(19) United States
(12) Patent Application Publication
(10) Pub. No.: US 2012/0306749 A1
(43) Pub. Date: Dec. 6, 2012

(54) TRANSPARENT USER INTERFACE LAYER

(76) Inventors: Eric Liu, Santa Clara, CA (US); Gabriel Rowe, Fremont, CA (US)

(21) Appl. No.: 13/149,437

(22) Filed: May 31, 2011

(51) Int. Cl. G06F 3/033; G06F 3/041

(52) U.S. Cl. 345/163; 345/173

(57) ABSTRACT

Embodiments of the present invention disclose a transparent layer for a touch-sensitive computing device. According to one embodiment, the computing device includes a touch user interface for displaying a plurality of interactive screens and for receiving input from an operating user. Furthermore, the touch user interface includes a touch interface layer and a transparent interface layer. When a drawing tool is used for input from the user, the input is registered as drawing input to be associated with the transparent interface layer.

### BACKGROUND

Providing efficient and intuitive interaction between a computer system and users thereof is essential for delivering an engaging and enjoyable user-experience. Today, most computer systems include a keyboard for allowing a user to manually input information into the computer system, and a mouse for selecting or highlighting items shown on an associated display unit. As computer systems have grown in popularity, however, alternate input and interaction systems have been developed.

For example, touch-sensitive, or touchscreen computer systems allow a user to physically touch the display unit and have that touch registered as an input at the particular touch location, thereby enabling a user to interact physically with objects shown on the display. Moreover, pen-like or stylus devices provide a natural user interface to computing systems by enabling for input and a means for drawing graphics using certain applications. However, drawings can be much more powerful than simply a tool for creating graphics. For example, when individuals take notes on paper, they may highlight, circle, and/or annotate in ways that are much more free and natural than input methods permitted on today's computing systems.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIGS. 1A and 1B are front views of a touch interface layer and a transparent graphical layer according to an example of the present invention.

FIG. 2 is a simplified block diagram of the system implementing the transparent layer for a touch-sensitive computing device according to an example of the present invention

FIG. 3 is a three-dimensional perspective view of a computing device implementing the transparent interface layer and global markups according to an example of the present invention.

FIG. 4 is an illustration of a computing device implementing the transparent interface layer and webpage annotation according to an example of the present invention.

FIG. 5 is a three-dimensional d awing of a search method using the global markups associated with the transparent interface layer according to an example of the present invention.

FIG. 6 is a flow chart of the processing steps for providing user input utilizing the transparent interface layer according to an example of the present invention.

### DETAILED DESCRIPTION OF THE INVENTION

The following discussion is directed to various embodiments. Although one or more of these embodiments may be discussed in detail, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to intimate that the scope of the disclosure, including the claims, is limited to that embodiment. Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

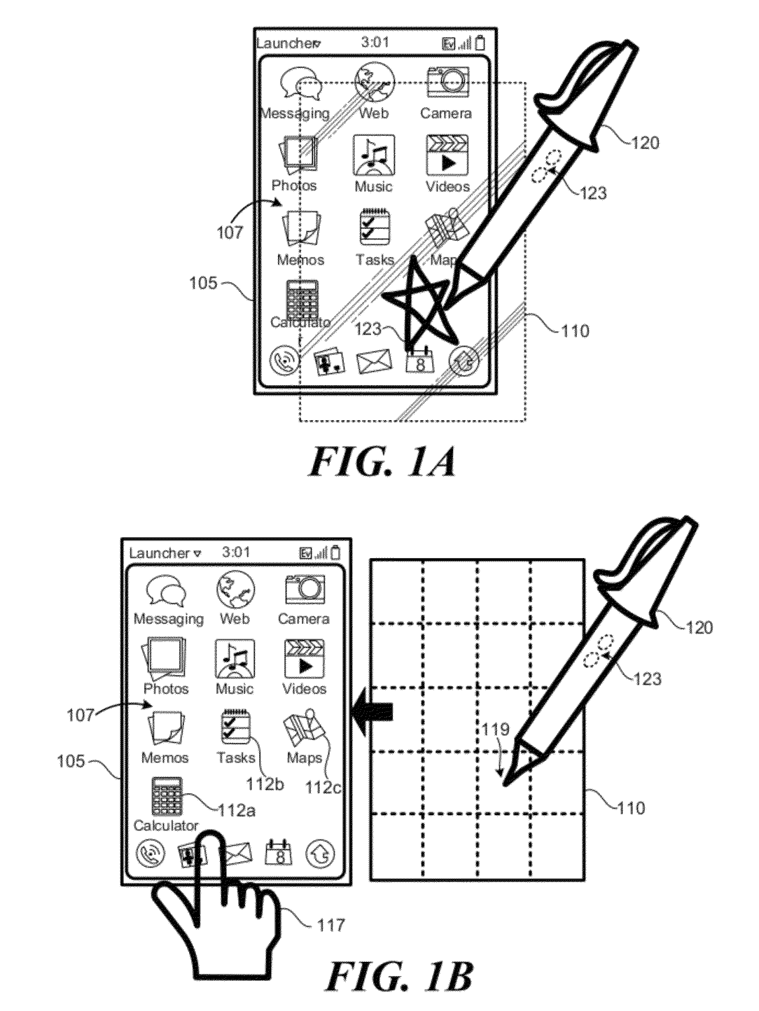

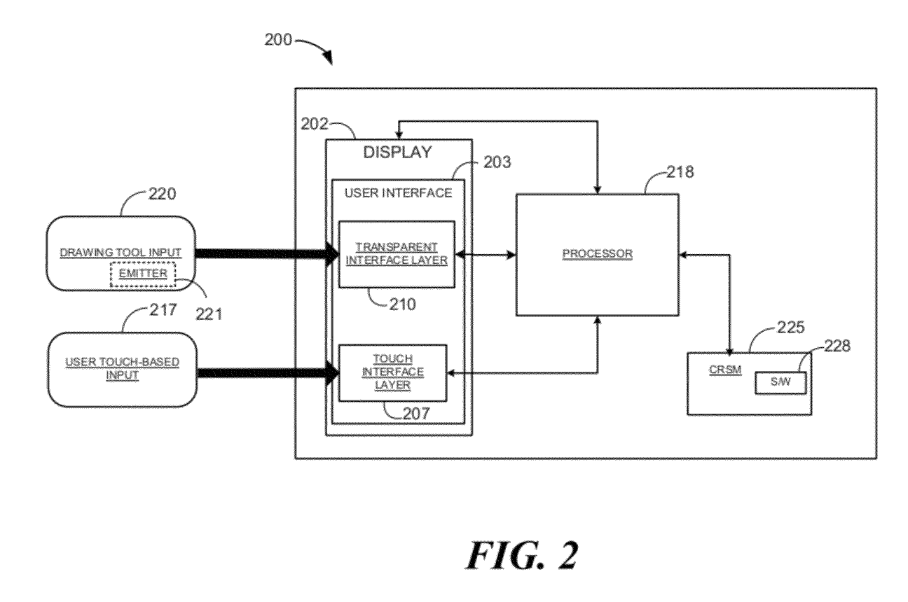

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated no as to provide a number of additional examples of the present disclosure. In addition, the proportion and the relative scale of the elements provided in the figures are intended to illustrate the examples of the present disclosure, and should not be taken in a limiting sense.

Currently, pen or drawing input in computing devices is generally limited to special drawing applications such as Adobe® Photoshop® or similar image editing programs, with the pen or drawing tool having limited use in other applications. Generally, the pen is configured to replicate the actions of a mouse or a finger. This type of modal interaction makes pen-style input often confusing as it sometimes interacts as a drawing device and sometimes as a pointing or selecting device. This issue arises because drawings created by a pen-style device are typically bitmap images, while applications and the system interface work with objects. As a result, many application programs are configured to automatically convert pen-style input into objects. For example, when the user draws a box in a drawing program, the completed graphic is converted into a box object. The next time the user tries to add a drawing stroke to the box object, the additional stroke is treated as a single object not linked to the previously created box. In most cases, however, drawing input is not even allowed, and the pen input is just interpreted as a touch event used for navigation of the operating system or application.

Examples of the present invention disclose a transparent user interface layer for a computing device. According to one example embodiment, every interactive screen of a touch interface layer of the computing device is paired with a transparent interface layer, which is may lie above the touch interface layer (e.g., with respect to the system software) of the computing device. A drawing tool, such as a pen stylus, may interact only with the transparent interface layer so as to create graphics and/or bitmap images, while detection of a mouse, finger or other input means is interpreted as a desired interaction with the touch interface layer below.

Referring now in more detail to the drawings in which like numerals identify corresponding parts throughout the views, FIGS, 1A and 1B are simplified illustrations of system software implementing a touch interface layer and a transparent interface layer according to an example of the present invention. FIG. 1A depicts a transparent interface layer 110 juxtaposed with a touch interface layer 105 of a computing device. Accordingly to one example, the software 105 of the computing devices includes a touch-sensitive operating system and user interface 107 configured to accept touch input from an operating user 117. The user interface 107 is configured to display interactive screens including a plurality of interactive objects 112a-112c for selection by the operating user 117. According to one example, the transparent interface layer 110 represents transparent electrode layer that lies above the touch interface layer 107 within system software 105 and is used for receiving and rendering drawing input from a user using a drawing tool 120. The drawing tool 120 may be a pen-like device such as a pen stylus, ballpoint pen, or similar instrument capable of creating a visual graphic on the transparent layer 110. That is, the user interacts with the display or user interface layer 107 via a finger or other body part, while the drawing tool 120 is used by the user to interact with transparent interface layer 110.

According to one example, the transparent interface layer 110 may represent a unique pattern of faint and visually unobstrusive reference symbols or characters deposited and embedded on the front cover screen of the computing device as shown in FIG. 1B. In the present example, the transparent interface layer 110 includes a checkered pattern of dots (and may include any other discernible pattern) formed on the front surface of the display. The drawing tool 120 may include a camera or optical sensor formed near its tip 119 such that data pertaining to the location of the drawing tool tip 119 on the transparent interface layer 110 may be calculated by recognizing the unique dot pattern via the optical sensor of the drawing tool, with the location-related data then being transmitted back to the processing unit for analysis and rendering. Normal touch interaction (via a finger for example) may be detected using a second active electronic touch interface layer 107 as in FIG. 1A, which would be located (with respect to the software) below the dot pattern layer or transparent interface layer 110. Such a configuration is advantageous over prior methods by allowing the contact surface and user interface to be very simple with few electronic parts. In addition, drawing input options such as color, and brush width, may be controlled on the touch interface level via standard interface tools (e.g., finger and mouse). Alternatively, the drawing tool 120 may also be equipped with selection mechanism(s) 123 to control drawing options so as to limit the need for additional interfaces. For example, the drawing tool 120 may include buttons or switches 123 formed thereon that may be used to change the color or line width, while the back of the drawing tool 120 may be used to erase graphics or images previously input using the transparent interface layer 110. Additionally, the drawing tool 120 may include a mode button 123 that switches the drawing tool 120 from a drawing mode to a selection mode, thereby allowing the user to quickly switch from drawing interaction with the transparent interface layer 110 to selection and touch interaction with the touch interface layer 107.

FIG. 2 is a simplified block diagram of the system implementing the transparent layer for a touch-enabled computing device according to an example of the present invention. As shown in this example, the system 200 includes a processor 218 coupled to a display unit 202, a touch user interface including a touch interface layer 207 and a transparent interface layer 210, and a computer-readable storage medium 225. In one embodiment, processor 218 represents a central processing unit (CPU), microcontroller, microprocessor, or logic configured to execute programming instructions associated with the touch-enabled device and computing system 200. Display unit 202 represents an electronic visual and touch-sensitive display configured to display images and the graphical touch user interface 203 for enabling touch-based input interaction 217 between the user and the computing device 202. The user interface 203 and/or touch interface layer 207 is configured to display interactive screens for facilitating user interaction with the computing device 200. More particularly, the interactive screens represent every screen or page displayed on the computing device 200 including applications and screenshots thereof, webpages, system settings pages, home pages, etc. According to one example, the transparent interface layer 210 represents an electronic contact-based interface that uses transparent electrodes to transmit a signal from the drawing tool 220 to the processing unit for providing both location of the drawing tool's tip for example, in addition to information such as pressure on the tip, whether buttons are activated, tilt angle of the drawing tool, and any other built-in features of drawing tool 120. The data could be transmitted by creating a unique signal in the touch interface or could use a secondary antenna near the touch interface. Data could also be transmitted to the processing unit via a wireless communication signal such as radio frequency. Bluetooth®, or similar personal area network schema. Furthermore, the communications can be bidirectional as well such that the processing unit 218 could issue a command to the drawing tool 220 to go into a high power state when the drawing tool 220 comes into proximity of the transparent interface layer 210. Still further, more complex data may be transmitted, for example, the drawing tool 220 may be equipped with an optical sensor for taking a picture, which can then be transmitted to the processing unit 218. According to one example embodiment, the drawing tool 220 includes an emitter 221 for communicating to the processing unit 218 the presence or contact of the drawing tool with the transparent layer 210. Storage medium 225 represents volatile storage (e.g. random access memory), non-volatile store (e.g. hard disk drive, read-only memory, compact disc read only memory, flash storage, etc.), or combinations thereof. Furthermore, storage medium 225 includes software 228 that is executable by processor 218 and, that when executed, causes the processor 218 to perform some or all of the functionality described herein.

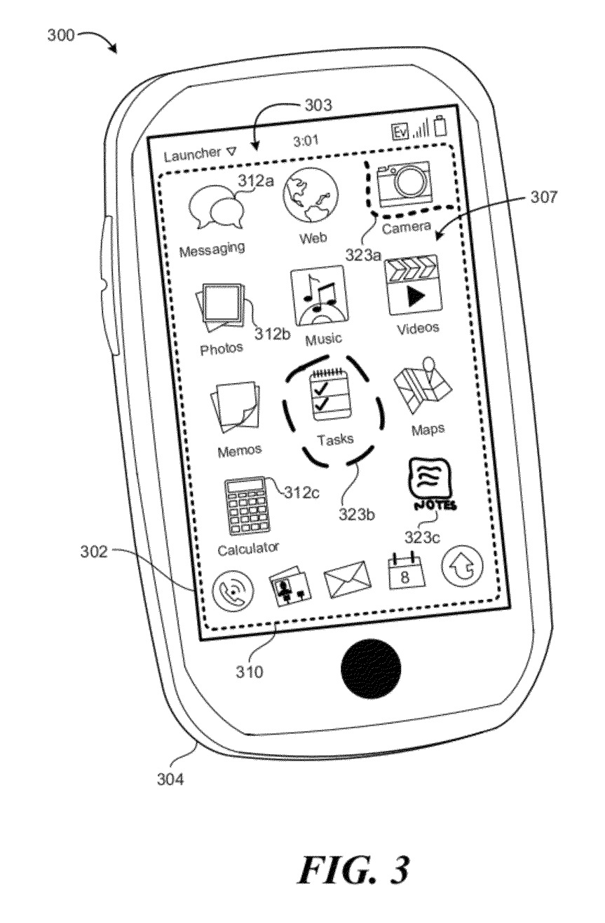

FIG. 3 is a three-dimensional perspective view of a computing device implementing the transparent layer and global markups according to an example of the present invention. As shown in the present example, the computing device 302 is represented as a smartphone device having a housing 304 supporting a touch-sensitive display 302 configured to display a touch user interface 303. The user interface includes (i.e., programmed therein) a touch interface layer 307 and a transparent interface layer 310 for facilitating input from the operating user. As mentioned before, the transparent interface layer 310 within the user interface software enables the user to jot down notes, graphics, or make markups on the transparent layer using a drawing tool. In one example, an operating user could jot down a high score on an interactive display screen of a game application, or write down the color or volume settings the user prefers for a certain application. That is, in addition to customary functions such as putting application icons in folders or arranging them spatially, examples of the present invention allow a user to draw graphics (e.g., 323a-323c) on top of user interface objects or application icons (e.g., 312a-312c) and have the graphic(s) associated with the particular interactive screen or object that the graphic(s) was thereon inscribed. Moreover, the drawing tool and transparent interface layer 310 would allow users to decorate application icons, group them together, or highlight (e.g., 323a and 323b) them without changing their individual functionality.

In addition, examples of the present invention may allow graphics from the transparent graphical layer 310 to be “pushed down” or electronically transferred via the processing unit into the touch interface layer 307. For instance, the operating user could use the drawing tool to draw and edit an image (e.g. 332c). The image 332c can be converted to a bitmap for example and an area of the bitmap image can be selected and “pushed down” into the user interface layer 307 so as to become an icon having interactive properties and selectable by the user. Similarly, a bitmap image may also be pulled back up into the transparent interface layer 310 from the user interface layer 307 for further editing. Conversely, any object within the user interface layer 307 may be made editable by “pulling up” (i.e., electronically transferred via the processing unit) the object into the transparent interface layer 310. For example, the photo application icon 312b may be converted to a bitmap image by the processing unit and “pulled up” into the transparent interface layer 310 for editing by the user via the drawing tool.

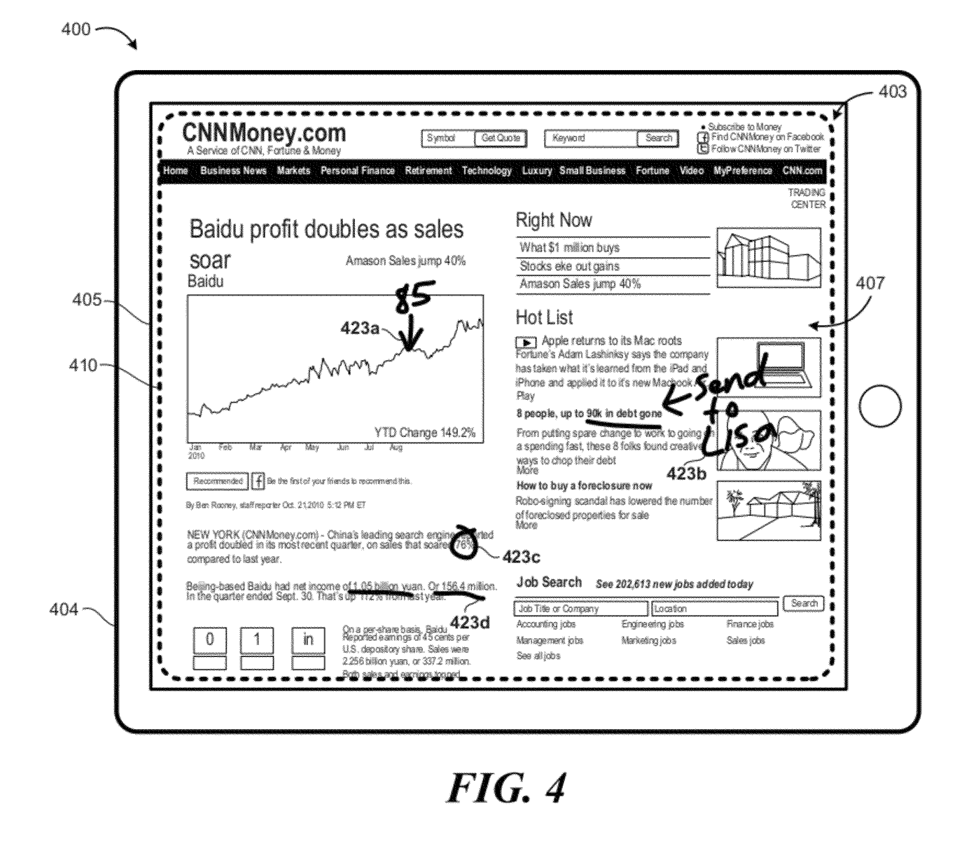

FIG. 4 is an illustration of a computing device implementing the multi-input layers and webpage annotation according to an example of the present invention. In the present example, a tablet personal computer is represented as the computing device 402. As in the previous example, the computing device 402 includes a housing 404 for a display unit 405. The display unit 404 displays the operating system or user interface 403, which includes the touch interface layer 407 and the transparent graphical layer 410. Here, the user interface 403 and/or touch interface layer 407 is currently displaying a webpage interactive screen to the user. When browsing the web, the transparent graphical layer 410 remains present with the touch interface layer 407 such that notes, highlights, markups and drawings may be added on top of the displayed webpage (e.g., interactive screen 407) via the drawing tool. Upon closing the web browsing application and returning to interactive webpage 407 for example, the previous markups or graphics 423a-423d would also reload as the transparent graphical layer 410 is directly linked or coupled with that webpage or interactive screen 407 of the touch interface layer. Graphics or markups may be drawn on top of a calendar application, gaming programs, tasks, or any other application associated with the computing device. In each scenario, the transparent graphical layer 410 would remain on top of the associated scene or page of the application such that markups and graphics inscribed thereon are directly coupled (via programming logic of the operating system/user interface) with the current scene or page of the application.

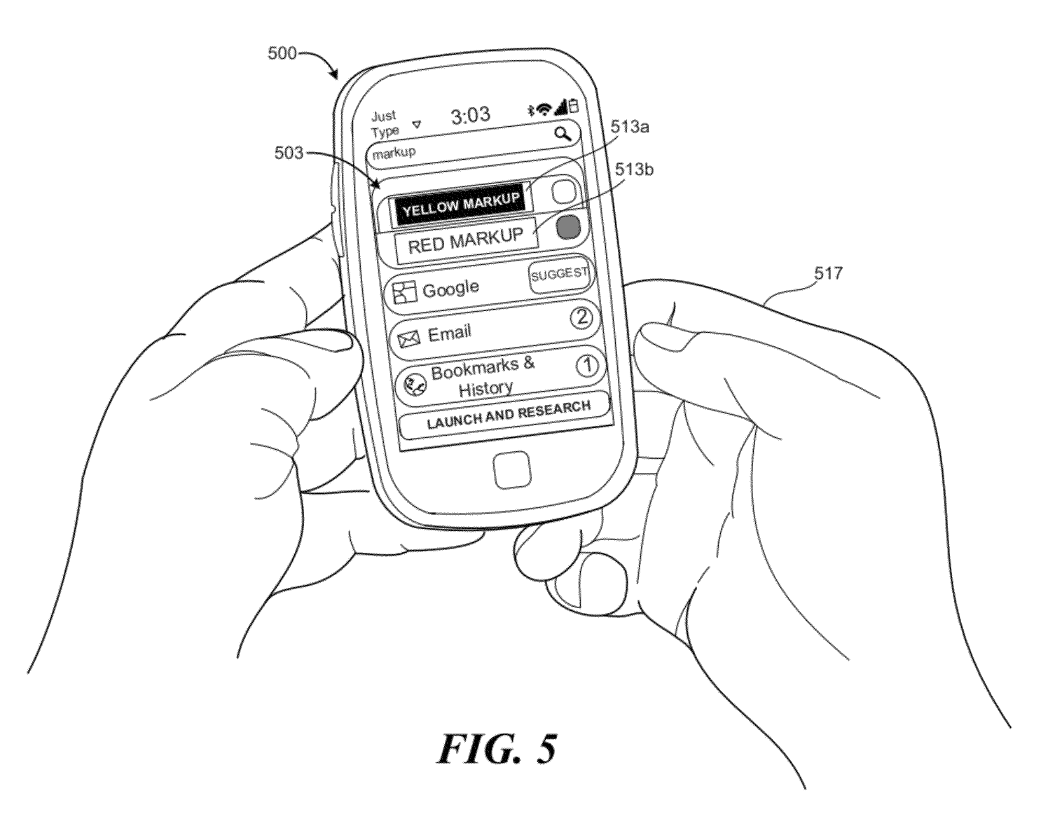

FIG. 5 is a three-dimensional drawing of a search method using the global markups associated with the transparent layer in accordance with an example of the present invention. According to one example, the transparent layer may allow for searching for items that have been highlighted or marked-up (i.e., global markup tags) using a particular color by the drawing tool. For example, a user may interact with the user interface 503 to search in email 530, webpages (bookmarks and history 532), and/or third party applications for items having a yellow markup 513a or a red markup 513b associated with the transparent layer. If the user desires to use global markups and the transparent layer as a means of finding items quickly, the user may simply annotate items using the drawing tool as a quick shortcut. In prior solutions, it is often difficult to mark a particular location such as the brightness setting, wireless network configuration, or a favorite page or place in an application.

Global markup tags could be searched for by color, shape, date, or by application usage. For example, the global markup tag could be used as a word tagging capability in an ebook reader application, or could be used as a photo editing function in the photo application. In another example, if a user 517 desires to upload multiple pictures and webpages, the global markup tags could be used to quickly identify a number of target pictures and webpages to upload or share on a social networking website. To accomplish such a task using examples of the present invention, the user would simply mark-up a number of the items using the drawing tool, perform a search to group the items all together, and then upload all the matching items as a block onto the desired social networking platform. In prior systems, the same task would require the user to find each picture separately and upload each picture one at a time, while exiting that application would likely interrupt the entire upload session. Examples of the present invention enable grouping of multiple items together from disparate places on a computing device within an overarching framework such as the global markup layer thus providing true global aggregation functionality and enabling the system to perform various time-consuming tasks for the user upon command.

Another example of a scenario utilizing the global markup tags and transparent interlace layer would be a user preparing for a business trip. In this example, the user may receive four separate communications relating to the business trip: 1) an email from the airline detailing the flight itinerary and confirmation code, 2) a hotel itinerary email with directions to the hotel, 3) a text or voice message from the foreign contact that the user will meet upon arrival, and 4) a to-do list of notes for the trip. In prior solutions, the traveling user may attempt to copy and paste information from each of these sources into an email or document for local viewing on the computing device, or simply write down the information from each separate source. According to an example of the present invention, markup tagging each item with a red box for example, may allow for data aggregation in addition to providing a preview of content within the red box and also give a link back to the original location of the data source (i.e., email, text message, etc.). When searching for the items tagged with “red box” and within the “last day” for example, the user could name the search result items as “China trip November 2011.” Consequently, when user walks into the airport or hotel, they may simply select this search-related term (e.g., China Trip November 2011”) and have all the important travel information instantly populated on the computing device.

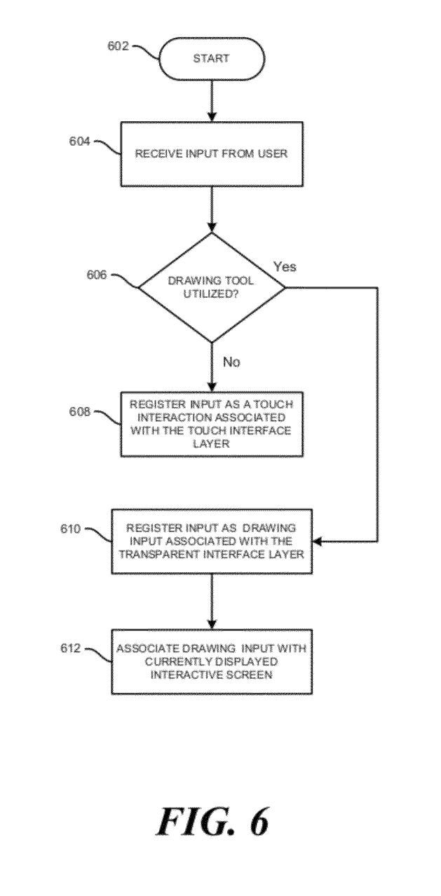

FIG. 6 is a flow chart of the processing steps for providing user input utilizing the transparent layer according to an example of the present invention. In step 602, the processing unit detects and receives input from an operating user. Next, the processing unit determines whether a drawing tool was utilized during user input in step 606. According to one example, transparent electrodes of the transparent interface layer communicate with a signal from the drawing tool to indicate the presence and/or contact of the drawing tool to the processing unit. In addition, location information of the drawing tool with respect to the on-screen location, pressure information with respect to contact of drawing tool's tip on the display screen, button activation or tilt angle of the drawing tool, and the like may be communicated by the transparent interface layer. A wireless communication signal such as radio frequency. Bluetooth, or some other personal area network scheme may also be utilized for transferring information between the drawing tool and computing device (e.g., transparent interface layer). Alternatively, the transparent interlace layer may be a unique and unobtrusive dot (or similar) pattern detectable by a camera or optical sensor formed on the tip of the drawing tool. In such a case, data pertaining to the contact and location of the drawing tool tip on the transparent interface layer may be calculated by recognizing the unique dot pattern via the optical sensor of the drawing tool, which is then transmitted back to the processing unit for analysis and rendering. In either case, in step 610, the processing unit registers the received input from the user as drawing input associated with the transparent interface layer. Thereafter, in step 612, the processing unit associates the received drawing input with the current display or interactive screen of the touch interface layer. On the other hand, if the processing unit determines that the user has directly touched (e.g., via a finger or other body party) the front surface of the display, then in step 608 the received input on the user interface is registered as touch input associated with the touch interface layer.

Moreover, several advantages are afforded by the multi-layered touch sensitive device that always treats the drawing tool as a writing interface. For example, throughout the operating system and user interface, any use of the drawing tool would provide writing or drawing functionality. Accordingly, usage of a pen stylus for example would be enabled in all applications and interactive screens even at the system level user interface. Furthermore, customization of every interactive screen would make the system interface more usable and more personal for the operating user.

Furthermore, while the invention has been described with respect to exemplary embodiments, one skilled in the art will recognize that numerous modifications are possible. For example, although exemplary embodiments depict a smartphone and table personal computer as the representative computing device, the invention is not limited thereto. For example, the computing device may be a netbook, an all-in-one desktop personal computer, or similar electronic device having touch-sensitive display functionality. Thus, although the invention has been described with respect to exemplary embodiments, it will be appreciated that the invention is intended to cover all modifications and equivalents within the scope of the following claims.

What is claimed is:

1. A method for input on a computing device having a touch user interface for displaying a plurality of interactive screens, the method comprising:
receiving, from an operating user, input on the touch user interface of the computing device, wherein the touch user interface includes a touch interface layer and a transparent interface layer;
registering the input as drawing input to be associated with the transparent interface layer when a drawing tool is used for the input.

2. The method of claim 1, further comprising:
associating the drawing input on the transparent interface layer with a currently displayed interactive screen of the touch user interface.

3. The method of claim 1, further comprising:
registering input as a touch input on the touch interface layer when the drawing tool is not recognized.

4. The method of claim 1, further comprising:
differentiating touch input from an operating user associated with the user interface layer from drawing input from the drawing tool based on a signal emitted by the drawing tool.

5. The method of claim 1, wherein the drawing input includes a color or graphical symbol for identifying a selected item associated with the application program or the operating system.

6. The method of claim 1, wherein the drawing tool is used to interact only with the transparent layer.

7. The method of claim 1, wherein the drawing tool can be switched to interact with either the touch interface layer or the transparent interface layer.

8. The method of claim 7, wherein a finger or mouse can be switched to interact with either the touch interface layer or the transparent interface layer

9. The method of claim 1, wherein any graphic inscribed on the transparent interface layer may be displayed in the touch interface layer such that the graphic may be selected and given interactive properties in the touch interface layer.

10. The method of claim 9, wherein any object shown in the touch interface layer can be converted into an image capable of being edited within the transparent interface layer.

11. A computing device having a touch-sensitive display, the device comprising:
a user interface configured to display a plurality of interactive screens on the display, wherein the user interface further comprises:
a touch interface layer for facilitating touch-based input received from an operating user; and
a transparent interface layer having a pattern embedded on a surface of the display and utilized to process drawing input from an operating user using a drawing tool,
wherein when drawing input is inscribed on the transparent interface layer via the drawing tool, said drawing input is coupled with at least one interactive screen of the touch interface layer.

12. The device of claim 11, wherein drawing input is differentiated from touch input based on a signal emitted by the drawing tool.

13. The device of claim 11 wherein the drawing input includes a color or graphical symbol for identifying a selected item associated with an interactive screen of the touch interface layer.

14. The device of claim 11, wherein the drawing tool includes an optical sensor for detecting the pattern of the transparent interface layer.

15. The device of claim 14, wherein a location of the drawing tool with respect to transparent layer is determined based on image data of the transparent layer pattern received from the drawing tool.

16. The device of claim 11, wherein the drawing tool can be switched to interact with either the touch interface layer or the transparent interface layer.

17. The device of claim 16, wherein a finger or mouse can be switched to interact with either the touch interface layer or the transparent interface layer.

18. The device of claim 11, wherein any graphic inscribed on the transparent interface layer may be electronically transferred onto the touch interface layer such that the graphic may be selected and given interactive properties in the user interface.

19. The device of claim 18, wherein any object associated with the touch interface layer can be converted into an image and edited on the transparent interface layer.

20. A computer readable storage medium for a computing device having a touch user interface, the computer readable storage medium having stored executable instructions, that when executed by a processor, causes the processor to:
receive, from an operating user, input on the touch user interface of the computing device, wherein the touch user interface includes a touch interface layer and a transparent interface layer;
register the input as drawing input to be associated with the transparent interface layer when a drawing tool is utilized for the input, or as touch input to be associated with the touch interface layer when the drawing tool is not utilized for the input;
associate the drawing input on the transparent interface layer with a currently displayed interactive screen of the of the touch interface layer.
